(19) United States
(12) Patent Application Publication
(10) Pub. No.: US 2009/0320222 A1
(43) Pub. Date: Dec. 31, 2009

(54) Cleaning Tool for a Pipe

(75) Inventor: Are Sandkleiva, Kvernaland (NO)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Aker Well Service AS, Stavanger (NO)

(21) Appl. No.: 12/095,965

(22) PCT Filed: Dec. 5, 2006
(86) PCT No.: PCT/NO06/00460

§ 371 Date: Aug. 28, 2008

(30) Foreign Application Priority Data
Dec. 5, 2005 (NO) 20055737

(51) Int. Cl. B08B 9/04

(52) U.S. Cl. 15/104.13

(57) ABSTRACT

A cleaning tool for a pipe, the cleaning tool being moved inside the pipe while rotating in the main about the longitudinal axis of the pipe, and the cleaning tool including, in addition to a mount, at least two cleaning bodies which are rotatable about their respective individual shafts, the cleaning bodies being provided with an uneven surface, at least part of the external active uneven surface of the cleaning bodies facing the internal mantle surface of the pipe.

This invention relates to a cleaning tool for a pipe. More particularly, it relates to a cleaning tool which is moved inside the pipe while rotating about the longitudinal axis of the pipe, the cleaning tool including, in addition to a mount, at least two cleaning bodies which are rotatable about their respective individual shafts. The bodies are provided with an uneven surface, at least part of the external active uneven surface of the cleaning bodies facing the internal mantle surface of the pipe. The cleaning tool is particularly well suited for removing scales in a pipe.

In the further description the cleaning of a pipe with scales has been taken as a basis, such an operation adequately emphasizing the advantageous features of the cleaning tool. However, the range of use of the cleaning tool is not in any way limited to such work, as it will be useable for a number of operations in which pipes or boreholes are to be cleaned or expanded, and in which a so-called “pilot hole” is present.

During the operation of pipe systems of different kinds, it is well known that, with time, scales may build up on the internal mantle surface of the pipe. This is particularly unfavorable when long pipes are involved, to which access is difficult and in which chemical cleaning methods are not very effective.

It is known to use so-called cleaning pigs for the cleaning of pipes. The cleaning pig is moved through a pipe by means of differential pressure and scrapes away scales from the pipe mantle. However, there is a limit to how large pressure difference that may be used and, thus, how large feeding force the cleaning pig may be subjected to.

Thus, with relatively considerable scales, for example such as known from the recovery of petroleum, cleaning equipment resembling a drill bit has to be used, in which the drill bit is driven by, for example, a rotating drill string or coiled tubing. It is evident that the rigging of such equipment is relatively extensive, and it has also turned out that the equipment may damage the pipe if, for example, the drill bit jams in the pipe.

The invention has as its object to remedy or reduce at least one of the drawbacks of the prior art.

The object is achieved in accordance with the invention through the features specified in the description below and in the Claims that follow.

According to the invention, in a cleaning tool which is moved inside the pipe while rotating about the longitudinal axis of the pipe, the cleaning tool includes in addition to a mount, at least two cleaning bodies which are rotatable about their respective individual shafts, at least part of the external active uneven surface of the cleaning bodies facing the internal mantle surface of the pipe.

It is advantageous that principally the individual shafts extend tilted from the centre axis of the pipe rearwards relative to the working direction of the cleaning tool. The number of cleaning bodies and, thereby, shafts must be at least two, but with three or four as preferred embodiments, to achieve a favorable cleaning effect.

In a preferred embodiment the cleaning bodies have been given a conical shape which has its smallest diameter in the feeding direction. At its opposite end portion, where the conical shape has its largest diameter, the cone merges into a spherical shape.

This spherical part of the cleaning body is thus disposed near the internal mantle surface of the pipe.

The cleaning bodies are formed with an uneven surface. Most advantageously, the cleaning bodies belonging to a cleaning tool are formed with unevennesses of different patterns. For example, one cleaning body may be provided with grooves and ridges extending radially around the cleaning body. A second cleaning body may have grooves and ridges extending helically at an angle to the rotary shaft, whereas a third cleaning body may have grooves and ridges extending helically at an angle in the opposite direction relative to the rotary shaft axis. A fourth cleaning body may be provided with pyramids or cones projecting from the surface of the cleaning body. The operation of said unevennesses will be explained in the particular part of the description.

When the cleaning tool is rotated about the longitudinal axis of the pipe while, at the same time, being moved into the pipe, the cleaning bodies come into contact with scales, first by their spherical portions which are located the nearest to the internal mantle surface of the pipe. Thereby, the cleaning bodies are set into rotation about their respective shafts, thus rolling on the mantle surface of the pipe or the scales present on the mantle surface.

Due to their conical and spherical shapes, the cleaning bodies exert a relatively great force in the radial direction of the pipe. Thereby, the unevennesses of the cleaning bodies are brought to penetrate and break up the scales.

If thicker scales have been allowed to build up, the portion of the scales facing the centre of the pipe will abute the conical portion of the cleaning body. The cleaning bodies, which are rotating about their respective axes of rotation, will tear up and loosen these inner layers of scales.

The cleaning tool is not suitable for the cleaning of completely blocked pipes, as the cleaning tool requires a pilot hole in order to be moved forward.

The cleaning tool enables the loosening of, for example, scales by the use of a relatively small displacement force in the longitudinal direction of the pipe. The necessary torque on the cleaning tool is also, due to the rolling contact of the cleaning bodies, relatively modest. The cleaning tool may, with advantage, be mounted on a downhole tractor's drive shaft, which rotates about the centre axis of the pipe, or on coiled tubing.

In what follows, is described a non-limiting example of a preferred embodiment which is visualized in the accompanying drawings, in which:

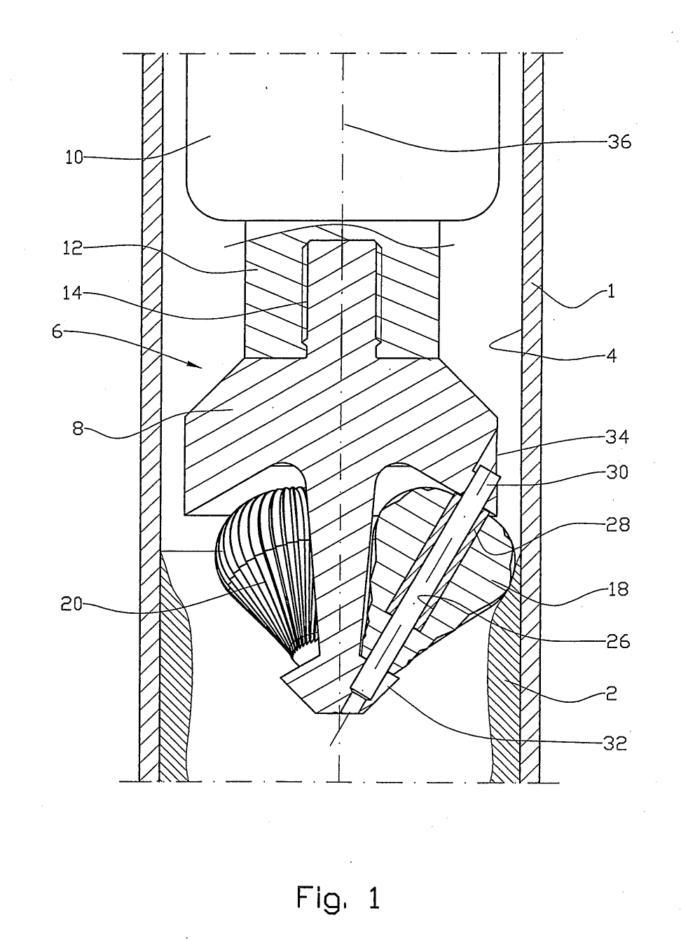

FIG. 1 shows, in section, a cleaning tool according to the invention, which is connected to a downhole tractor and which is in a pipe under cleaning;

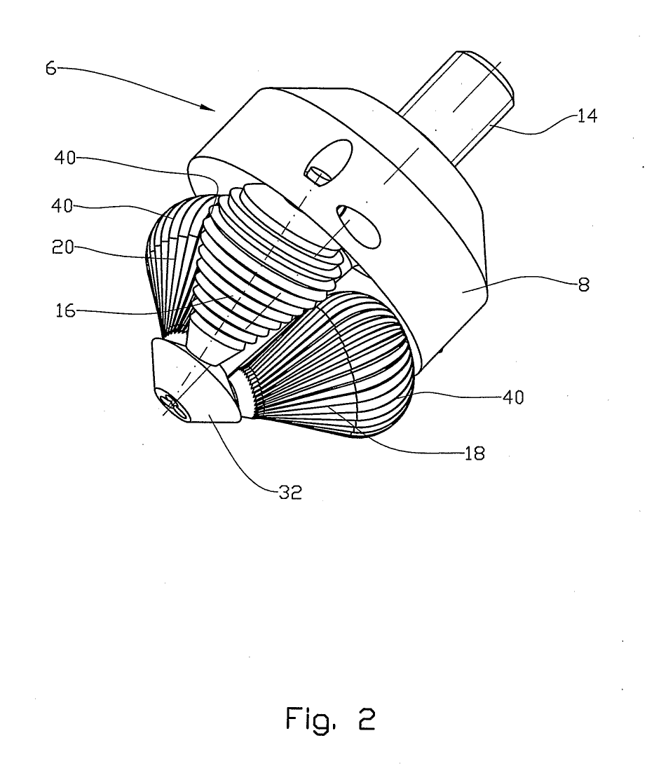

FIG. 2 shows a perspective view of the cleaning tool;

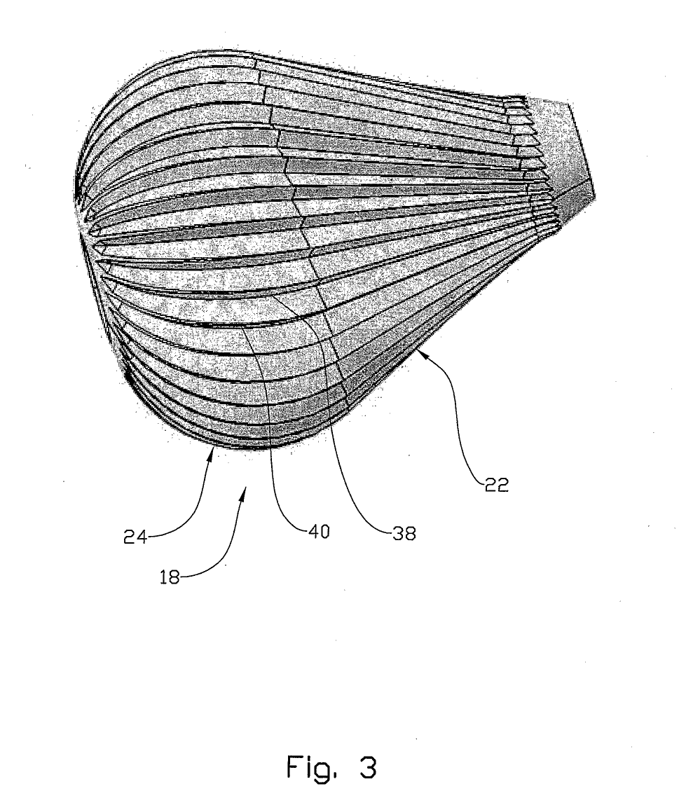

FIG. 3 shows a side view of a cleaning body; and

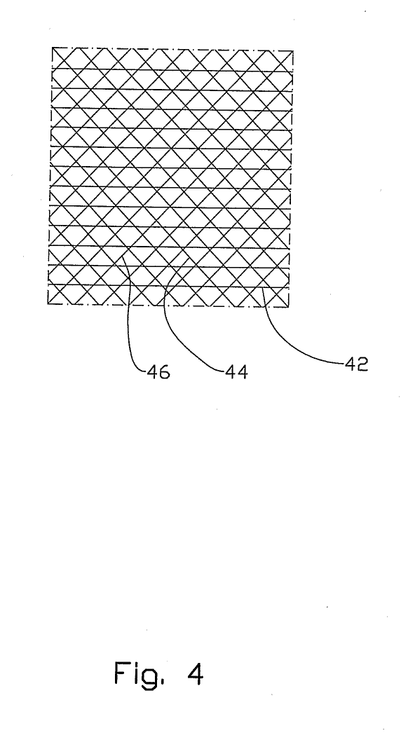

FIG. 4 shows a cleaning pattern from the cleaning tool of FIG. 2.

In the drawings the reference numeral 1 indicates a pipe where scale layer 2 has been built up on the internal mantle surface 4 of the pipe 1.

A cleaning tool 6 includes a mount 8 which is connected to the drive shaft 12 of a downhole tractor 10 by means of a threaded connection 14.

The cleaning tool 6 is provided with a first cleaning body 16, a second cleaning body 18 and a third cleaning body 20. The first cleaning body 16 is not shown in FIG. 1. FIG. 3 shows the second cleaning body 18.

The cleaning bodies 16, 18 and 20 are formed with a conical portion 22 merging into a spherical portion 24, see FIG. 3. In a central through bore 26 in the cleaning bodies 16, 18, 20 is arranged a bushing 28 which is rotatable about a shaft 30.

The shafts 30 extend between a central projection 32 at the free end portion of the mount 8 and at an angle outwards to the external cylinder surface 34 of the mount 8. The shafts 30 are evenly spaced around the centre axis 36 of the pipe 1.

The cleaning bodies 16, 18, 20 are arranged around their respective shafts 30, the smallest diameter of the conical portion 22 facing the projection 32, whereas the spherical portion 24 is the nearest to the external cylinder surface 34.

Each of the cleaning bodies 16, 18, 20 is provided with grooves 38 and relatively sharp ridges 40, see FIG. 3. The first cleaning body 16 is provided with ridges 40 extending radially, surrounding the first cleaning body 16. The second cleaning body 18 has ridges 40 extending in a right-handed helical shape, whereas the third cleaning body 20 is provided with ridges 40 extending in a left-handed helical shape.

When the cleaning tool 6 is rotated about the centre axis 36 while, at the same time, being moved into the pipe 1, the cleaning bodies 16, 18, 20 engage the scale 2, as is illustrated in FIG. 1.

The cleaning bodies 16, 18, 20 are set into rotation about their respective shafts 30 and the ridges 40 are forced into the scale 2.

FIG. 4 shows a pattern, in which the ridges 40 of the first cleaning body 16 leave the traces 42 in the scale 2. If the scale 2 is not broken up sufficiently, the second cleaning body 18 comes and imparts the traces 44 to the scale, whereas the traces 46 stem from the third cleaning body 20 rolling next across the scale 2.

The different patterns from ridges 40 of the cleaning bodies 16, 18, 20 thus have the effect that the scale 2 is given a relatively fine-meshed trace pattern 42, 44, 46 which contributes to breaking up efficiently the scale 2.

1. A cleaning tool for a pipe, the cleaning tool being moved inside the pipe while rotating about an axis parallel to the longitudinal axis of the pipe, and where the cleaning tool includes, in addition to a mount, at least two cleaning bodies that are rotatable about their respective individual shafts, the cleaning bodies being provided with an uneven surface, and where at least part of the external active uneven surface of the cleaning bodies are facing the internal mantle surface of the pipe, and where the cleaning bodies have a conical shape and have its smallest diameter facing in the feeding direction, wherein the conical shape is merging, at its largest diameter, into a spherical portion, whereby the spherical portion of the cleaning body is disposed close to the internal mantle surface of the pipe.

2. The device in accordance with claim 1, wherein the individual shafts extend tilted from the centre axis of the pipe and outwards from the centre axis.

3. The device in accordance with claim 1, wherein the uneven surface one cleaning body is unlike the surface of the rest of the cleaning bodies.

4. The device in accordance with claim 1, wherein the surface of the cleaning body includes a number of grooves with intermediate, relatively sharp ridges.

5. The device in accordance with claim 4, wherein the ridges surround the cleaning body radially.

6. The device in accordance with claim 4, wherein the ridges extend helically along the cleaning body.

7. The device in accordance with claim 1, wherein the surface of the cleaning body includes a number of cones or pyramids.
